(19) United States
(12) Patent Application Publication
(10) Pub. No.: US 2021/0398360 A1
(43) Pub. Date: Dec. 23, 2021

(54) Generating Content Based on State Information

(71) Applicant: Apple Inc., Cupertino, CA (US)

(72) Inventors: Mark Drummond, Palo Alto, CA (US); Bo Morgan, Emerald Hills, CA (US)

(21) Appl. No.: 17/465,342

(22) Filed: Sep. 2, 2021

Related U.S. Application Data
(63) Continuation of application No. PCT/US2020/028968, filed on Apr. 20, 2020.
(60) Provisional application No. 62/837,289, filed on Apr. 23, 2019.

(51) Int. Cl. G06T 19/00; G06T 15/00; G06K 9/62; G06K 9/00

(52) U.S. Cl. CPC G06T 19/006; G06T 19/003; G06K 2209/21; G06K 9/6215; G06K 9/00711; G06T 15/005

(57) ABSTRACT

A method includes determining a first portion of state information that is accessible to a first agent instantiated in an environment. The method includes determining a second portion of the state information that is accessible to a second agent instantiated in the environment. The method includes generating a first set of actions for a representation of the first agent based on the first portion of the state information to satisfy a first objective of the first agent. The method includes generating a second set of actions for a representation of the second agent based on the second portion of the state information to satisfy a second objective of the second agent. The method includes modifying the representations of the first and second agents based on the first and second set of actions.

### CROSS-REFERENCE TO RELATED APPLICATION

This application is a continuation of Intl. Patent App. No. PCT/US2020/28968, filed on Apr. 20, 2020, which claims priority to U.S. Provisional Patent App. No. 62/837,289, filed on Apr. 23, 2019, which are both hereby incorporated by reference in their entirety.

### TECHNICAL FIELD

The present disclosure generally relates to generating content based on state information.

### BACKGROUND

Some devices are capable of generating and presenting environments. Some devices that present environments include mobile communication devices such as smartphones, head-mountable displays (HMDs), eyeglasses, heads-up displays (HUDs), and optical projection systems.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a diagram of an example operating environment in accordance with some implementations.

FIG. 2A is a block diagram of an example system that generates content based on state information in accordance with some implementations.

FIG. 2B is a block diagram of an example objective-effectuator engine that generates actions based on state information in accordance with some implementations.

FIG. 2C is a block diagram of an example emergent content engine that generates objectives based on state information in accordance with some implementations.

FIGS. 3A-3B are block diagrams of example objective-effectuator engines that generate actions based on state information in accordance with some implementations.

FIGS. 4A-4C are flowchart representations of a method of generating actions for objective-effectuators based on state information in accordance with some implementations.

FIG. 5 is a block diagram of a device enabled with various components of an objective-effectuator engine that generates actions based on state information in accordance with some implementations.

FIGS. 6A-6B are block diagrams of an example emergent content engine that generate objectives based on state information in accordance with some implementations.

FIGS. 7A-7B are flowchart representations of a method of generating objectives for objective-effectuators based on state information in accordance with some implementations.

FIG. 8 is a block diagram of a device enabled with various components of an emergent content engine that generates objectives based on state information in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for generating actions for representations of objective-effectuators (e.g., agents, for example, intelligent agents or virtual intelligent agents) based on state information. In some implementations, the method includes determining a first portion of state information that is accessible to a first agent instantiated in an environment. In some implementations, the state information characterizes one or more portions of the environment. In some implementations, the method includes determining a second portion of the state information that is accessible to a second agent instantiated in the environment. In some implementations, the second portion of the state information is different from the first portion of the state information. In some implementations, the method includes generating a first set of actions for a representation of the first agent based on the first portion of the state information to satisfy a first objective of the first agent. The first set of actions is within a degree of similarity to actions that a first entity that the first agent models performs in a fictional material. In some implementations, the method includes generating a second set of actions for a representation of the second agent based on the second portion of the state information to satisfy a second objective of the second agent. The second set of actions is within a degree of similarity to actions that a second entity that the second agent models performs in the fictional material. In some implementations, the method includes modifying the representations of the first and second agents based on the first and second set of actions.

Various implementations disclosed herein include devices, systems, and methods for generating an objective for an XR representation of an objective-effectuator based on state information. In some implementations, the method includes obtaining a set of predefined actions for a representation of an objective-effectuator. In some implementations, the method includes generating an objective for the XR representation of the objective-effectuator based on the set of predefined actions and a first portion of state information characterizing the XR environment. In some implementations, the first portion of the state information is different from a second portion of the state information accessible to the objective-effectuator. In some implementations, the method includes triggering the XR representation of the objective-effectuator to perform one or more actions in order to satisfy the objective.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The present disclosure provides methods, systems, and/or devices for generating extended reality (XR) content based on state information that characterizes an XR environment. Utilizing the state information that characterizes the XR environment results in XR content that is more believable. For example, when an objective-effectuator engine (e.g., an agent engine) utilizes state information that is accessible to a corresponding objective-effectuator (e.g., agent), then the objective-effectuator engine generates more believable actions for an XR representation of the objective-effectuator. Similarly, when an emergent content engine utilizes state information to generate objectives, the objectives result in environment-integrated content (e.g., content that is based on a state of the XR environment).

An XR environment can include XR representations of multiple objective- effectuators (e.g., agents, for example, intelligent agents or virtual intelligent agents). Each objective-effectuator may have limited access to a portion of the state information that characterizes the XR environment. For example, an XR representation of an objective-effectuator may have detected (e.g., observed) a portion of the XR environment, and gained access to a corresponding portion of the state information. However, collectively, the objective-effectuators may have access to the entirety of the state information. For example, the XR representations of the objective-effectuators, collectively, may have detected the entire XR environment. Each objective-effectuator engine generates corresponding actions based on respective portions of the state information that the corresponding objective-effectuators can access. Since an objective-effectuator engine does not utilize portions of the state information that are not accessible to the corresponding objective-effectuator, the actions generated by the objective-effectuator appear more believable.

An emergent content engine may have access to a portion of the state information that is different from the portions of the state information that are accessible to the objective-effectuators. For example, the emergent content engine may have access to a greater portion of the state information than a particular objective-effectuator. The emergent content engine generates objectives for XR representations of objective-effectuators based on a portion of the state information that is different from portions of the state information that the objective-effectuators can access. Utilizing the state information to generate objectives results in environment-integrated objectives. For example, the objectives account for a state of the XR environment. Generating objectives based on a portion of the state information that is different from another portion accessible to an objective-effectuator results in broad objectives which trigger the objective-effectuator to discover new information by exploring different parts of the XR environment.

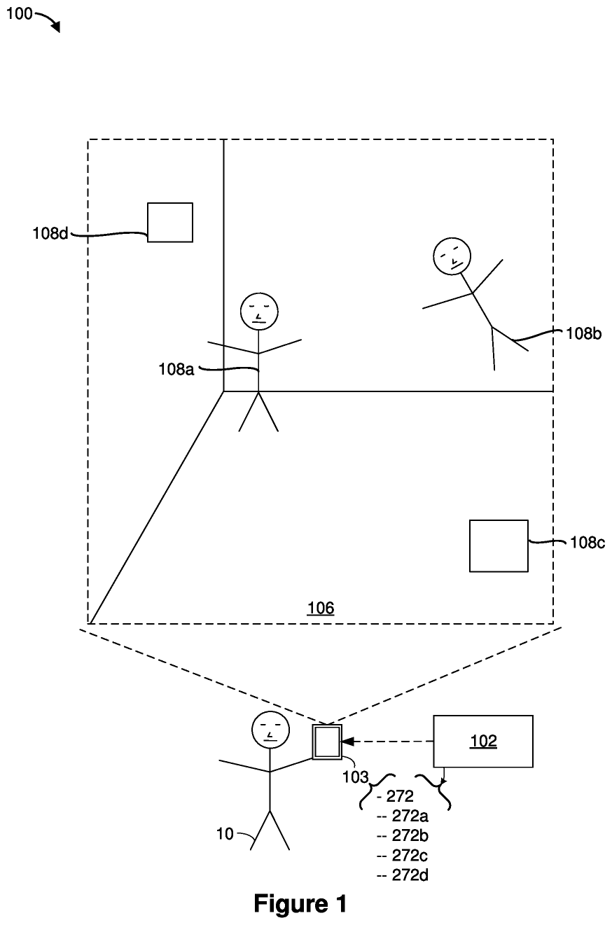

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 102 and an electronic device 103. In the example of FIG. 1, the electronic device 103 is being held by a user 10. In some implementations, the electronic device 103 includes a smartphone, a tablet, a laptop, or the like.

As illustrated in FIG. 1, the electronic device 103 presents an extended reality (XR) environment 106. In some implementations, the XR environment 106 is generated by the controller 102 and/or the electronic device 103. In some implementations, the XR environment 106 includes a virtual environment that is a simulated replacement of a physical environment. In other words, in some implementations, the XR environment 106 is synthesized by the controller 102 and/or the electronic device 103. In such implementations, the XR environment 106 is different from the physical environment where the electronic device 103 is located. In some implementations, the XR environment 106 includes an augmented environment that is a modified version of a physical environment. For example, in some implementations, the controller 102 and/or the electronic device 103 modify (e.g., augment) a representation of the physical environment where the electronic device 103 is located in order to generate the XR environment 106. In some implementations, the controller 102 and/or the electronic device 103 generate the XR environment 106 by simulating a replica of the physical environment where the electronic device 103 is located. In some implementations, the controller 102 and/or the electronic device 103 generate the XR environment 106 by removing and/or adding items from the simulated replica of the physical environment where the electronic device 103 is located.

In some implementations, the XR environment 106 includes various XR representations of objective-effectuators. In the example of FIG. 1, the XR environment 106 includes a boy action figure representation 108a that represents a boy objective-effectuator (e.g., a boy agent) which models a ‘boy action figure’ character. The XR environment 106 includes a girl action figure representation 108b that represents a girl objective-effectuator (e.g., a girl agent) which models a ‘girl action figure’ character. The XR environment 106 includes a robot representation 108c that represents a robot objective-effectuator (e.g., a robot agent) which models a robot. The XR environment 106 includes a drone representation 108d that represents a drone objective-effectuator (e.g., a drone agent) which models a drone.

In some implementations, the objective-effectuators represent (e.g., model behavior of) characters from fictional materials, such as movies, video games, comics, and novels. For example, the ‘boy action figure’ character represented by the boy action figure representation 108a is from a fictional comic, and the ‘girl action figure’ character represented by the girl action figure representation 108b is from a fictional video game. In some implementations, the XR environment 106 includes objective-effectuators that represent characters from different fictional materials (e.g., from different movies/games/comics/novels). In various implementations, the objective-effectuators represent things (e.g., the objective-effectuators model behavior of tangible objects). For example, in some implementations, the objective-effectuators represent equipment (e.g., machinery such as planes, tanks, robots, cars, etc.). In the example of FIG. 1, the robot representation 108c represents a robot and the drone representation 108d represents a drone. In some implementations, the objective-effectuators represent things (e.g., equipment) from fictional materials. In some implementations, the objective-effectuators represent (e.g., model behavior of) physical elements from a physical environment.

In various implementations, the objective-effectuators perform one or more actions in order to effectuate (e.g., complete, satisfy, achieve and/or advance) one or more objectives. In some implementations, the objective-effectuators perform a sequence of actions. In some implementations, the controller 102 and/or the electronic device 103 determine the actions that the objective-effectuators perform. In some implementations, the actions of the objective-effectuators are within a degree of similarity to actions that the corresponding entities (e.g., characters or things) perform in the fictional material. In the example of FIG. 1, the girl action figure representation 108b is performing the action of flying (e.g., because the corresponding ‘girl action figure’ character is capable of flying, and/or the ‘girl action figure’ character frequently flies in the fictional materials). In the example of FIG. 1, the drone representation 108d is performing the action of hovering (e.g., because drones in physical environments are capable of hovering). In some implementations, the controller 102 and/or the electronic device 103 obtain the actions for the objective-effectuators. For example, in some implementations, the controller 102 and/or the electronic device 103 receive the actions for the objective-effectuators from a remote server that determines (e.g., selects) the actions.

In various implementations, an objective-effectuator performs an action in order to satisfy (e.g., complete/satisfy/achieve/advance) an objective. In some implementations, an objective-effectuator is associated with a particular objective, and the objective-effectuator performs actions that improve the likelihood of satisfying that particular objective. In some implementations, XR representations of the objective-effectuators are referred to as XR objects. In some implementations, an objective-effectuator representing a character is referred to as a character objective-effectuator. In some implementations, a character objective-effectuator performs actions to effectuate a character objective. In some implementations, an objective-effectuator representing an equipment is referred to as an equipment objective-effectuator. In some implementations, an equipment objective-effectuator performs actions to effectuate an equipment objective. In some implementations, an objective-effectuator representing an environment is referred to as an environmental objective-effectuator. In some implementations, an environmental objective-effectuator performs environmental actions (e.g., provides environmental responses) to effectuate an environmental objective.

In various implementations, an objective-effectuator is referred to as an agent. For example, in some implementations, an objective-effectuator is referred to as an intelligent agent. In some implementations, an objective-effectuator is referred to as a virtual intelligent agent (VIA). As described herein, in various implementations, an agent performs an action in order to satisfy (e.g., complete or achieve) an objective of the agent. In various implementations, the agent obtains the objective from a human operator (e.g., the user 10 of the electronic device 103). For example, in some implementations, the agent generates responses to queries that the user 10 of the electronic device 103 inputs into the electronic device 103. In some implementations, the agent synthesizes vocal responses to voice queries that the electronic device 103 detects. In various implementations, the agent performs electronic operations on the electronic device 103. For example, the agent composes messages in response to receiving an instruction from the user 10 of the electronic device 103. In some implementations, the agent schedules calendar events, sets timers/alarms, provides navigation directions, reads incoming messages, and/or assists the user 10 in operating the electronic device 103.

In some implementations, the XR environment 106 is generated based on a user input from the user 10. For example, in some implementations, the electronic device 103 receives a user input indicating a terrain for the XR environment 106. In such implementations, the controller 102 and/or the electronic device 103 configure the XR environment 106 such that the XR environment 106 includes the terrain indicated via the user input. In some implementations, the user input indicates environmental conditions for the XR environment 106. In such implementations, the controller 102 and/or the electronic device 103 configure the XR environment 106 to have the environmental conditions indicated by the user input. In some implementations, the environmental conditions include one or more of temperature, humidity, pressure, visibility, ambient light level, ambient sound level, time of day (e.g., morning, afternoon, evening, or night), and precipitation (e.g., overcast, rain, or snow). In some implementations, the user input specifies a time period for the XR environment 106. In such implementations, the controller 102 and/or the electronic device 103 maintain and present the XR environment 106 during the specified time period.

In some implementations, the controller 102 and/or the electronic device 103 determine (e.g., generate) actions for the objective-effectuators based on a user input from the user 10. For example, in some implementations, the electronic device 103 receives a user input indicating placement of the XR representations of the objective-effectuators. In such implementations, the controller 102 and/or the electronic device 103 position the XR representations of the objective-effectuators in accordance with the placement indicated by the user input. In some implementations, the user input indicates specific actions that the objective-effectuators are permitted to perform. In such implementations, the controller 102 and/or the electronic device 103 select the actions for the objective-effectuators from the specific actions indicated by the user input. In some implementations, the controller 102 and/or the electronic device 103 forgo actions that are not among the specific actions indicated by the user input.

In various implementations, the controller 102 and/or the electronic device 103 generate actions for the XR representations of the objective-effectuators based on state information 272 characterizing the XR environment 106. In some implementations, the controller 102 and/or the electronic device 103 generate actions for an XR representation of a particular objective-effectuator based on a portion of the state information 272 that is accessible to that particular objective-effectuator. In the example of FIG. 1, a first portion 272a of the state information 272 is accessible to the boy objective-effectuator represented by the boy action figure representation 108a. As such, the controller 102 and/or the electronic device 103 generate actions for the boy action figure representation 108a based on the first portion 272a of the state information 272. Similarly, the controller 102 and/or the electronic device 103 generate actions for the girl action figure representation 108b based on a second portion 272b of the state information 272 that is accessible to the girl objective-effectuator represented by the girl action figure representation 108b. The controller 102 and/or the electronic device 103 generate actions for the robot representation 108c based on a third portion 272c of the state information 272 that is accessible to the robot objective-effectuator represented by the robot representation 108c. The controller 102 and/or the electronic device 103 generate actions for the drone representation 108d based on a fourth portion 272d of the state information 272 that is accessible to the drone objective-effectuator represented by the drone representation 108d.

In various implementations, the state information 272 represents known information regarding the XR environment 106. For example, in some implementations, the state information 272 represents knowledge that exists in relation to the XR environment 106. In some implementations, the state information 272 is stored in the form of a graph. In such implementations, the state information 272 is referred to as a knowledge graph. In some implementations, the state information 272 is referred to as an ontology. In some implementations, the first portion 272a represents information that is accessible to the boy objective-effectuator. For example, the first portion 272a represents knowledge that the boy objective-effectuator possesses. In some implementations, the first portion 272a represents information that the boy action figure representation 108a has detected (e.g., observed) since the boy objective-effectuator was instantiated in the XR environment 106. The second portion 272b, the third portion 272c and the fourth portion 272d represent information that is accessible to the girl objective-effectuator, the robot objective-effectuator and the drone objective-effectuator, respectively.

In some implementations, the state information 272 is stored in the controller 102 and/or the electronic device 103. In some implementations, the controller 102 and/or the electronic device 103 obtain (e.g., retrieve) the state information 272 from a remote source. In some implementations, the controller 102 and/or the electronic device 103 generate the state information 272 by querying the objective-effectuators that are instantiated in the XR environment 106. For example, the controller 102 and/or the electronic device 103 generate the first portion 272a of the state information 272 by querying the boy objective-effectuator regarding the XR environment 106. As an example, the controller 102 and/or the electronic device 103 request the boy objective-effectuator to specify the XR objects that the boy action figure representation 108a has detected (e.g., observed or seen) in the XR environment 106. In some implementations, the controller 102 and/or the electronic device 103 request the boy objective-effectuator to specify the actions that the boy action figure representation 108a has performed in the XR environment 106. In some implementations, the controller 102 and/or the electronic device 103 request the boy objective-effectuator to specify the objectives of the boy objective-effectuator and the status of the objectives. In various implementations, the controller 102 and/or the electronic device 103 generate the first portion 272a based on the responses that the boy objective-effectuator provides. Similarly, the controller 102 and/or the electronic device 103 generate the second portion 272b, the third portion 272c and the fourth portion 272d based on the responses that the girl objective-effectuator, the robot objective-effectuator and the drone objective-effectuator provide. In various implementations, the controller 102 and/or the electronic device 103 generate the state information 272 based on the first portion 272a, the second portion 272b, the third portion 272c and the fourth portion 272d (e.g., by concatenating the different portions 272a . . . 272d).

In some implementations, a head-mountable device (HMD) (not shown), being worn by the user 10, presents (e.g., displays) the XR environment 106 according to various implementations. In some implementations, the HMD includes an integrated display (e.g., a built-in display) that displays the XR environment 106. In some implementations, the HMD includes a head-mountable enclosure. In various implementations, the head-mountable enclosure includes an attachment region to which another device with a display can be attached. For example, in some implementations, the electronic device 103 can be attached to the head-mountable enclosure. In various implementations, the head-mountable enclosure is shaped to form a receptacle for receiving another device that includes a display (e.g., the electronic device 103). For example, in some implementations, the electronic device 103 slides/snaps into or otherwise attaches to the head-mountable enclosure. In some implementations, the display of the device attached to the head-mountable enclosure presents (e.g., displays) the XR environment 106.

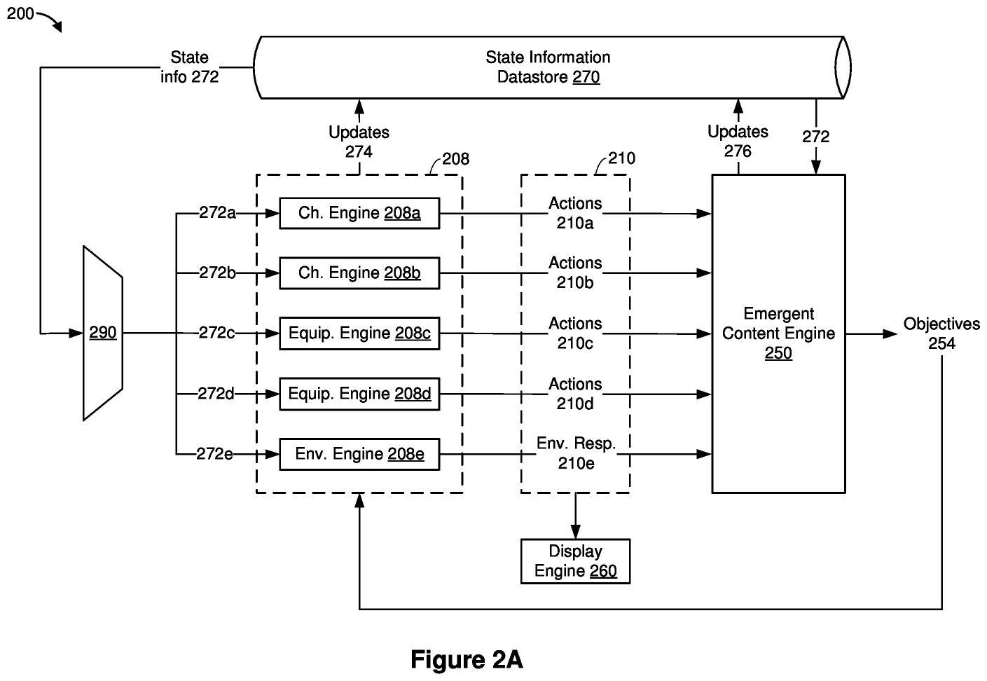

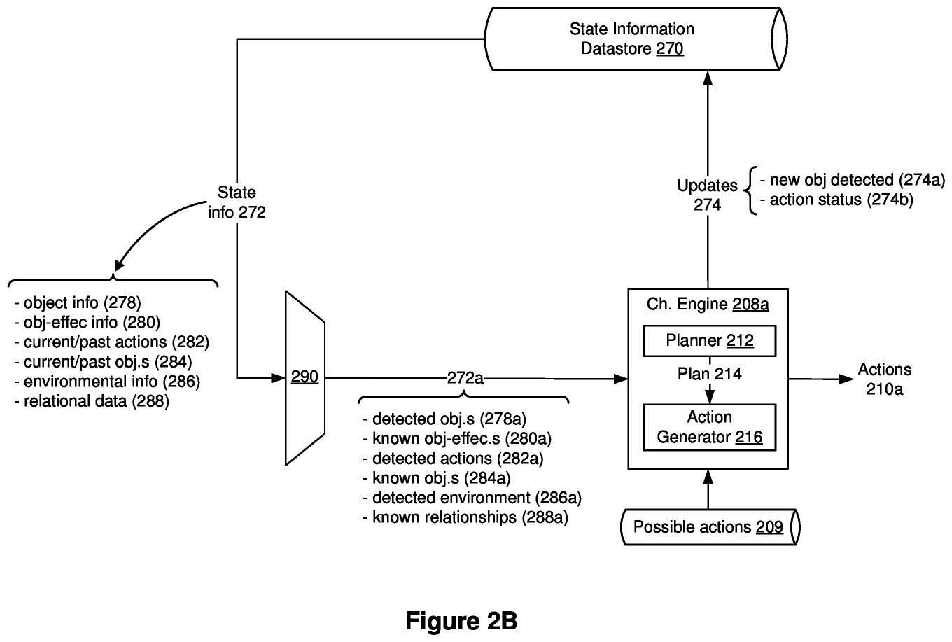

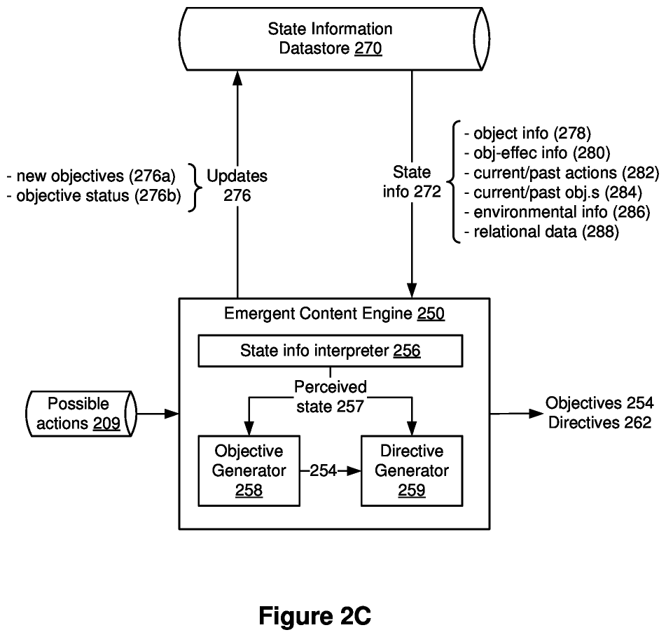

FIG. 2A is a block diagram of an example system 200 that generates XR content based on state information 272 characterizing an XR environment. To that end, the system includes objective-effectuator engines 208, an emergent content engine 250 and a state information datastore 270. In various implementations, the emergent content engine 250 generates objectives 254 for various objective-effectuators based on the state information 272. The objective-effectuators engines 208 generate actions 210 based on the state information 272 in order to advance the objectives 254. The objective-effectuator engines 208 provide the actions 210 to a display engine 260 that manipulates XR representations of corresponding objective-effectuators based on the actions 210. In some implementations, the objective-effectuator engine 208 are referred to as agent engines.

In the example of FIG. 2A, the objective-effectuator engines 208 include a first character engine 208a, a second character engine 208b, a first equipment engine 208c, a second equipment engine 208d, and an environmental engine 208e. The first character engine 208a generates a first set of actions 210a for the boy objective-effectuator. The second character engine 208b generates a second set of actions 210b for the girl objective-effectuator. The first equipment engine 208c generates a third set of actions 210c for the robot objective-effectuator. The second equipment engine 208d generates a fourth set of actions 210d for the drone objective-effectuator. The environmental engine 208e generates a fifth set of actions 210e (e.g., environmental responses) for an environment of the XR environment 106.

In some implementations, the system 200 includes a state information distributor 290 that distributes portions of the state information 272 to the objective-effectuator engines 208. In the example of FIG. 2A, the state information distributor 290 provides the first portion 272a to the first character engine 208a, the second portion 272b to the second character engine 208b, the third portion 272c to the first equipment engine 208c, the fourth portion 272d to the second equipment engine 208d, and a fifth portion 272e to the environmental engine 208e. More generally, in various implementations, the state information distributor 290 identifies a particular portion of the state information 272 that is accessible to an objective-effectuator, and provides that particular portion of the state information 272 to an objective-effectuator engine that generates actions for the objective-effectuator.

In various implementations, the objective-effectuator engines 208 utilize the corresponding portions of the state information 272 provided by the state information distributor 290 to generate the actions 210. For example, in some implementations, the first character engine 208a utilizes the first portion 272a of the state information 272 to generate the first set of actions 210a for the boy action figure representation 108a. Similarly, the second character engine 208b utilizes the second portion 272b of the state information 272 to generate the second set of actions 210b for the girl action figure representation 108b. The first equipment engine 208c utilizes the third portion 272c of the state information 272 to generate the third set of actions 210c for the robot representation 108c. The second equipment engine 208d utilizes the fourth portion 272d of the state information 272 to generate the fourth set of actions 210d for the drone representation 108d. The environmental engine 208e utilizes the fifth portion 272e of the state information to generate the fifth set of actions 210e for the environment of the XR environment 106.

In various implementations, the emergent content engine 250 generates objectives 254 for various objective-effectuators based on the state information 272. Since the emergent content engine 250 utilizes the state information 272 to generate the objectives 254, the objectives 254 are environment-integrated. For example, the objectives 254 are a function of a state (e.g., a current state, and/or one or more past states) of the XR environment 106. In other words, the objectives 254 account for conditions of the XR environment 106 indicated by the state information 272. As such, the objectives 254 result in more believable content. For example, the objectives 254 trigger actions 210 that are more believable given the state of the XR environment 106 indicated by the state information 272. In some implementations, the emergent content engine 250 has access to the entirety of the state information 272. In some implementations, the emergent content engine 250 has access to a portion of the state information 272 which is less than the entirety of the state information 272.

In various implementations, the emergent content engine 250 has access to different portions of the state information 272 than individual objective-effectuator engines 208. In some implementations, the emergent content engine 250 has access to a greater portion of the state information 272 than individual objective-effectuator engines 208. As such, the emergent content engine 250 generates broad objectives that trigger the XR representations of the objective-effectuators to discover new information and expand the portion of state information that the objective-effectuators can access. For example, the emergent content engine 250 utilizes a different portion of the state information 272 than the first portion 272a to generate an objective for the boy objective-effectuator. As such, in some implementations, the objective for the boy objective-effectuator triggers the boy action figure representation 108a to discover new information regarding the XR environment 106 in order to satisfy the objective.

In various implementations, the objective-effectuator engines 208 modify the state information 272 by generating updates 274 for the state information datastore 270. In some implementations, the updates 274 indicate the actions 210 that the objective-effectuator engines 208 generated. In some implementations, the updates 274 indicate which of the actions 210 have been completed and/or which of the actions 210 have not been completed. In some implementations, the updates 274 indicate new XR objects detected by the XR representations of the objective-effectuators. For example, the updates 274 indicate that the boy action figure representation 108a has detected a new XR object that the boy action figure representation 108a had not previously detected. In some implementations, the updates 274 indicate a status of the actions 210 (e.g., completed, partially completed, attempted, not attempted, etc.).

In various implementations, the emergent content engine 250 modifies the state information 272 by generating updates 276 for the state information datastore 270. In some implementations, the updates 276 indicate the objectives 254 that the emergent content engine 250 generated. In some implementations, the updates 276 indicate a status of the objectives 254 (e.g., completed, partially completed, attempted, not attempted, etc.). For example, in some implementations, the updates 276 indicate which of the objectives 254 have been completed and/or which of the objectives 254 have not been completed.

In various implementations, the objective-effectuator engines 208 provide the actions 210 to the display engine 260 (e.g., a rendering and display pipeline). In some implementations, the display engine 260 modifies the XR representations of the objective-effectuators and/or the environment of the XR environment 106 based on the actions 210. In various implementations, the display engine 260 modifies (e.g., manipulates) the XR representations of the objective-effectuators such that the XR representations of the objective-effectuator can be seen as performing the actions 210. For example, if an action for the girl action figure representation 108b is to fly, the display engine 260 moves the girl action figure representation 108b within the XR environment 106 in order to give the appearance that the girl action figure representation 108b is flying within the XR environment 106.

Referring to FIG. 2B, in various implementations, the state information 272 includes XR object information 278. In some implementations, the XR object information 278 indicates XR objects that exist within the XR environment 106. In some implementations, the first portion 272a of the state information 272 indicates detected XR objects 278a. In some implementations, the detected XR objects 278a indicate XR objects that the boy action figure representation 108a has detected (e.g., observed or seen). As such, in various implementations, the detected XR objects 278a are a subset of the XR object information 278.

In various implementations, the state information 272 includes objective-effectuator information 280. In some implementations, the objective-effectuator information 280 indicates objective-effectuators that are instantiated in the XR environment 106. In some implementations, the first portion 272a includes information regarding known objective-effectuators 280a. In some implementations, the known objective-effectuators 280a are objective-effectuators that the boy action figure representation 108a has detected. For example, the known objective-effectuators 280a are objective-effectuators that the boy objective-effectuator knows about. In some implementations, the known objective-effectuators 280a are a subset of the objective-effectuator information 280, for example, because the boy objective-effectuator does not know about all the objective-effectuators that are instantiated in the XR environment 106.

In various implementations, the state information 272 includes information regarding current/past actions 282. In some implementations, the current/past actions 282 include actions that have been performed by XR representations of objective-effectuators that are instantiated in an XR environment. For example, the current/past actions 282 include actions that the boy action figure representation 108a, the girl action figure representation 108b, the robot representation 108c and/or the drone representation 108d have performed in the XR environment 106. In some implementations, the current/past actions 282 include actions that XR representations of objective-effectuators are currently performing in an XR environment. In some implementations, the current/past actions 282 include actions that the XR representations of objective-effectuators are to perform within a threshold amount of time (e.g., within the next 1 hour).

In some implementations, the first portion 272a of the state information 272 includes information regarding detected actions 282a. In some implementations, the detected actions 282a include actions that the boy action figure representation 108a has detected in the past and/or is currently detecting. The detected actions 282a are a subset of the current/past actions 282, for example, because the boy action figure representation 108a has not detected all the actions that have been performed in the XR environment 106.

In various implementations, the state information 272 includes information regarding current/past objectives 284 of various objective-effectuators that are instantiated in an XR environment. For example, in some implementations, the current/past objectives 284 include current/past objectives of the boy objective-effectuator, the girl objective-effectuator, the robot objective-effectuator and/or the drone objective-effectuator instantiated in the XR environment 106. In some implementations, the current/past objectives 284 are associated with status information which indicates a progress of the current/past objectives 284 (e.g., completed, partially completed, attempted, not attempted, failed, etc.). In some implementations, the first portion 272a of the state information 272 includes information regarding known objectives 284a. In some implementations, the known objectives 284a are objectives that the boy objective-effectuator has detected. For example, the known objectives 284a include current/past objectives of the boy objective-effectuator. In some implementations, the known objectives 284a includes objectives of other objective-effectuators that the boy objective-effectuator has detected.

In various implementations, the state information 272 includes environmental information 286 regarding the XR environment 106. In some implementations, the environmental information 286 indicates a terrain of the XR environment 106. In some implementations, the environmental information 286 indicates weather conditions throughout the XR environment 106. In some implementations, the first portion 272a of the state information 272 includes detected environmental information 286a. In some implementations, the detected environmental information 286a includes a subset of the environmental information 286 that the boy objective-effectuator has detected (e.g., observed). For example, the detected environmental information 286a indicates a terrain and/or weather conditions for a portion of the XR environment 106 that the boy action figure representation 108a has traversed.

In various implementations, the state information 272 includes relational data 288. In some implementations, the relational data 288 indicates relationships between different XR objects within the XR environment. In some implementations, the relational data 288 indicates relationships between different objective-effectuators that are instantiated in the XR environment 106. In some implementations, the first portion 272a of the state information 272 indicates known relationships 288a. In some implementations, the known relationships 288a are relationships that the boy action figure representation 108a has detected. In some implementations, the known relationships 288a include relationships that the boy action figure representation 108a has with other XR objects within the XR environment 106.

In some implementations, the first character engine 208a includes a planner 212 and an action generator 216. The planner 212 generates a plan 214 based on the first portion 272a of the state information 272. The planner 212 provides the plan 214 to the action generator 216. The action generator 216 generates the first set of actions 210a in accordance with the plan 214. In various implementations, the planner 212 and the action generator 216 utilize a possible set of actions 209 to generate the plan 214 and the first set of actions 210a, respectively. For example, the planner 212 generates the plan 214 such that the plan 214 can be satisfied with one or more of the possible set of actions 209. In some implementations, the action generator 216 generates the first set of actions 210a by selecting the first set of actions 210a from the possible set of actions 209. In some implementations, the planner 212 and/or the action generator 216 are implemented by one or more neural network systems.

In some implementations, the updates 274 include information regarding newly detected XR objects 274a. In some implementations, the newly detected XR objects 274a indicate XR objects that the boy action figure representation 108a has detected (e.g., observed) in the XR environment 106. In some implementations, the updates 274 include a status 274b of the first set of actions 210a. For example, the status 274b indicates which of the first set of actions 210a have been completed, which of the first set of actions 210b have not been completed, which of the first set of actions 210b have been attempted, and/or which of the first set of actions 210b were attempted but could not be completed.

Referring to FIG. 2C, in various implementations, the emergent content engine 250 generates the objectives 254 and directives 262 for the objectives 254 based on the state information 272. To that end, as illustrated in FIG. 2C, in some implementations, the emergent content engine 250 includes a state information interpreter 256, an objective generator 258, and a directive generator 259. The state information interpreter 256 interprets the state information 272 and generates a perceived state 257 of the XR environment 106. The perceived state 257 represents an interpretation of the state information 272. The objective generator 258 generates the objectives 254 based on the perceived state 257. The directive generator 259 generates the directives 262 for the objectives 254 based on the perceived state 257. In some implementations, the state information interpreter 256 applies a bias to the state information 272. As such, in some implementations, the perceived state 257 is different from an actual state of the XR environment 106.

In some implementations, the objective generator 258 and the directive generator 259 utilize the possible set of actions 209 to generate the objectives 254 and the directives 262, respectively. In some implementations, the objective generator 258 and the directive generator 259 are implemented by one or more neural network systems. In various implementations, the directives 262 include guidance on how to satisfy the objectives 254. In some implementations, the directives 262 include boundary conditions for the objectives 254. In some implementations, the directives 262 narrow a scope of the objectives 254 (e.g., by restricting the objectives 254 to a particular time, location and/or behavior).

In some implementations, the updates 276 include information regarding newly created objectives 276a. For example, in some implementations, the updates 276 include the objectives 254 and/or the directives 262. In some implementations, the updates 276 include an objective status 276b. In some implementations, the objective status 276b indicates a progress of the objectives 254. In some implementations, the objective status 276b indicates which of the objectives 254 have been satisfied, which of the objectives 254 have not been satisfied, which of the objectives 254 have been attempted, and/or which of the objectives 254 were attempted but did not succeed.

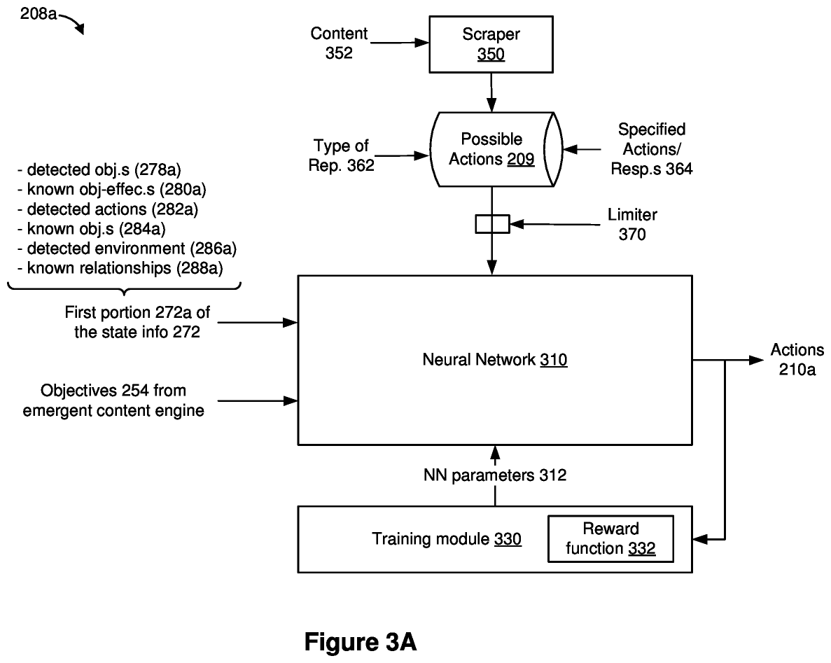

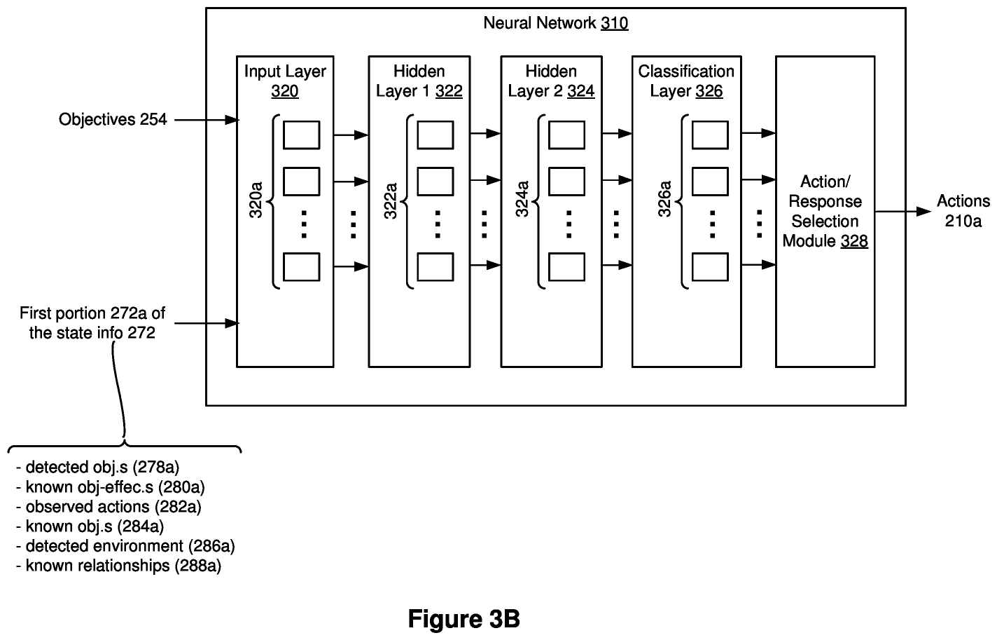

FIG. 3A is a block diagram of the first character engine 208a in accordance with some implementations. In various implementations, the first character engine 208a includes a neural network system 310 (“neural network 310”, hereinafter for the sake of brevity), a neural network training system 330 (“a training module 330”, hereinafter for the sake of brevity) that trains (e.g., configures) the neural network 310, and a scraper 350 that provides the possible set of actions 209 to the neural network 310. In various implementations, the neural network 310 generates the first set of actions 210a based on the first portion 272a of the state information 272 and the objectives 254.

In some implementations, the neural network 310 includes a long short-term memory (LSTM) recurrent neural network (RNN). In various implementations, the neural network 310 generates the first set of actions 210a based on a function of the possible set of actions 209. For example, in some implementations, the neural network 310 generates the first set of actions 210a by selecting a portion of the possible set of actions 209. In some implementations, the neural network 310 generates the first set of actions 210a such that the first set of actions 210a are within a degree of similarity to the possible set of actions 209.

In some implementations, the neural network 310 generates the first set of actions 210a based on the objectives 254 from the emergent content engine 250. In some implementations, the neural network 310 generates the first set of actions 210a in order to satisfy the objectives 254 from the emergent content engine 250. In some implementations, the neural network 310 evaluates the possible set of actions 209 with respect to the objectives 254. In such implementations, the neural network 310 generates the first set of actions 210a by selecting the possible set of actions 209 that satisfy the objectives 254 and forgoing selection of the possible set of actions 209 that do not satisfy the objectives 254.

In some implementations, the neural network 310 generates the first set of actions 210a based on the first portion 272a of the state information 272. For example, in some implementations, the first set of actions 210a include interfacing with the detected XR objects 278a. In some implementations, the first set of actions 210a include cooperating with XR representations of the known objective-effectuators 280a. In some implementations, the first set of actions 210a include performing actions that block the known objectives 284a of another objective-effectuator. In some implementations, the first set of actions 210a are generated based on the detected environmental information 286a. For example, if the environmental information 286a indicates rain within a portion of the XR environment 106 where the boy action figure representation 108a is located, then the first set of actions 210a include opening an ER umbrella. In some implementations, the first set of actions 210a utilize the known relationships 288a. For example, the first set of actions 210a include initiating a conversation with an XR representation of another objective-effectuator with whom there is a known relationship.

In various implementations, the training module 330 trains the neural network 310. In some implementations, the training module 330 provides neural network (NN) parameters 312 to the neural network 310. In some implementations, the neural network 310 includes a model of neurons, and the neural network parameters 312 represent weights for the neurons. In some implementations, the training module 330 generates (e.g., initializes/initiates) the neural network parameters 312, and refines the neural network parameters 312 based on the first set of actions 210a generated by the neural network 310.

In some implementations, the training module 330 includes a reward function 332 that utilizes reinforcement learning to train the neural network 310. In some implementations, the reward function 332 assigns a positive reward to actions that are desirable, and a negative reward to actions that are undesirable. In some implementations, during a training phase, the training module 330 compares the first set of actions 210a with verification data that includes verified actions. In such implementations, if the first set of actions 210a are within a degree of similarity to the verified actions, then the training module 330 stops training the neural network 310. However, if the first set of actions 210a are not within the degree of similarity to the verified actions, then the training module 330 continues to train the neural network 310. In various implementations, the training module 330 updates the neural network parameters 312 during/after the training.

In various implementations, the scraper 350 scrapes content 352 to identify the possible set of actions 209. In some implementations, the content 352 includes movies, video games, comics, novels, and fan-created content such as blogs and commentary. In some implementations, the scraper 350 utilizes various methods, systems, and devices associated with content scraping to scrape the content 352. For example, in some implementations, the scraper 350 utilizes one or more of text pattern matching, HTML (Hyper Text Markup Language) parsing, DOM (Document Object Model) parsing, image processing, and audio analysis in order to scrape the content 352 and identify the possible set of actions 209.

In some implementations, the boy objective-effectuator is associated with a type of representation 362, and the neural network 310 generates the first set of actions 210a based on the type of representation 362 associated with the objective-effectuator. In some implementations, the type of representation 362 indicates physical characteristics of the boy objective-effectuator, such as characteristics relating to its appearance and/or feel (e.g., color, material type, texture, etc.). In some implementations, the neural network 310 generates the first set of actions 210a based on the physical characteristics of the boy objective-effectuator. In some implementations, the type of representation 362 indicates behavioral characteristics of the boy objective-effectuator (e.g., aggressiveness, friendliness, etc.). In some implementations, the neural network 310 generates the first set of actions 210a based on the behavioral characteristics of the boy objective-effectuator. For example, the neural network 310 generates the action of fighting for the boy action figure representation 108a in response to the behavioral characteristics including aggressiveness. In some implementations, the type of representation 362 indicates functional characteristics of the boy objective-effectuator (e.g., strength, speed, flexibility, etc.). In some implementations, the neural network 310 generates the first set of actions 210a based on the functional characteristics of the boy objective-effectuator. For example, the neural network 310 generates a running action for the boy action figure representation 108a in response to the functional characteristics including speed. In some implementations, the type of representation 362 is determined based on a user input. In some implementations, the type of representation 362 is determined based on a combination of rules.

In some implementations, the neural network 310 generates the first set of actions 210a based on specified actions/responses 364. In some implementations, the specified actions/responses 364 are provided by an entity that controls the fictional materials from where the boy action figure originated. For example, in some implementations, the specified actions/responses 364 are provided (e.g., conceived of) by a movie producer, a video game creator, a novelist, etc. In some implementations, the possible set of actions 209 include the specified actions/responses 364. As such, in some implementations, the neural network 310 generates the first set of actions 210a by selecting a portion of the specified actions/responses 364.

In some implementations, the possible set of actions 209 for the boy objective-effectuator are limited by a limiter 370. In some implementations, the limiter 370 restricts the neural network 310 from selecting a portion of the possible set of actions 209. In some implementations, the limiter 370 is controlled by the entity that controls (e.g., owns) the fictional materials from where the boy action figure originated. For example, in some implementations, the limiter 370 is controlled (e.g., operated and/or managed) by a movie producer, a video game creator, and/or a novelist that created the boy action figure. In some implementations, the limiter 370 and the neural network 310 are controlled/operated by different entities. In some implementations, the limiter 370 restricts the neural network 310 from generating actions that breach a criterion defined by the entity that controls the fictional materials.

FIG. 3B is a block diagram of the neural network 310 in accordance with some implementations. In the example of FIG. 3B, the neural network 310 includes an input layer 320, a first hidden layer 322, a second hidden layer 324, a classification layer 326, and an action/response selection module 328 (“action selection module 328”, hereinafter for the sake of brevity). While the neural network 310 includes two hidden layers as an example, those of ordinary skill in the art will appreciate from the present disclosure that one or more additional hidden layers are also present in various implementations. Adding additional hidden layers adds to the computational complexity and memory demands, but may improve performance for some applications.

In various implementations, the input layer 320 is coupled (e.g., configured) to receive various inputs. In the example of FIG. 3B, the input layer 320 receives inputs indicating the objectives 254 and the first portion 272a of the state information 272. In some implementations, the neural network 310 includes a feature extraction module (not shown) that generates a feature stream (e.g., a feature vector) based on the objectives 254 and the first portion 272a of the state information 272. In such implementations, the feature extraction module provides the feature stream to the input layer 320. As such, in some implementations, the input layer 320 receives a feature stream that is a function of the objectives 254 and the first portion 272a of the state information 272. In various implementations, the input layer 320 includes a number of LSTM logic units 320a, which are also referred to as model(s) of neurons by those of ordinary skill in the art. In some such implementations, an input matrix from the features to the LSTM logic units 320a include rectangular matrices. The size of this matrix is a function of the number of features included in the feature stream.

In some implementations, the first hidden layer 322 includes a number of LSTM logic units 322a. In some implementations, the number of LSTM logic units 322a ranges between approximately 10-500. Those of ordinary skill in the art will appreciate that, in such implementations, the number of LSTM logic units per layer is orders of magnitude smaller than previously known approaches (being of the order of O(10¹)-O(10²)), which allows such implementations to be embedded in highly resource-constrained devices. As illustrated in the example of FIG. 3B, the first hidden layer 322 receives its inputs from the input layer 320.

In some implementations, the second hidden layer 324 includes a number of LSTM logic units 324a. In some implementations, the number of LSTM logic units 324a is the same as or similar to the number of LSTM logic units 320a in the input layer 320 or the number of LSTM logic units 322a in the first hidden layer 322. As illustrated in the example of FIG. 3B, the second hidden layer 324 receives its inputs from the first hidden layer 322. Additionally or alternatively, in some implementations, the second hidden layer 324 receives its inputs from the input layer 320.

In some implementations, the classification layer 326 includes a number of LSTM logic units 326a. In some implementations, the number of LSTM logic units 326a is the same as or similar to the number of LSTM logic units 320a in the input layer 320, the number of LSTM logic units 322a in the first hidden layer 322, or the number of LSTM logic units 324a in the second hidden layer 324. In some implementations, the classification layer 326 includes an implementation of a multinomial logistic function (e.g., a soft-max function) that produces a number of outputs that is approximately equal to a number of the possible set of actions 209. In some implementations, each output includes a probability or a confidence measure that the corresponding action satisfies the objective 254. In some implementations, the outputs do not include actions that have been excluded by operation of the limiter 370.

In some implementations, the action selection module 328 generates the first set of actions 210a by selecting the top N action candidates provided by the classification layer 326. In some implementations, the top N action candidates are most likely to satisfy the objectives 254. In some implementations, the action selection module 328 provides the first set of actions 210a to a rendering and display pipeline (e.g., the display engine 260 shown in FIG. 2A).

In various implementations, other objective-effectuator engines implement a neural network system that is similar to the neural network 310. For example, in some implementations, the second character engine 208b shown in FIG. 2A implements a neural network system that is similar to the neural network 310 in order to generate the second set of actions 210b. Similarly, in some implementations, the first equipment engine 208c shown in FIG. 2A implements a neural network system that is similar to the neural network 310 in order to generate the third set of actions 210c. Moreover, in some implementations, the environmental engine 208e shown in FIG. 2A implements a neural network system that is similar to the neural network 310 in order to generate the fifth set of actions 210e.

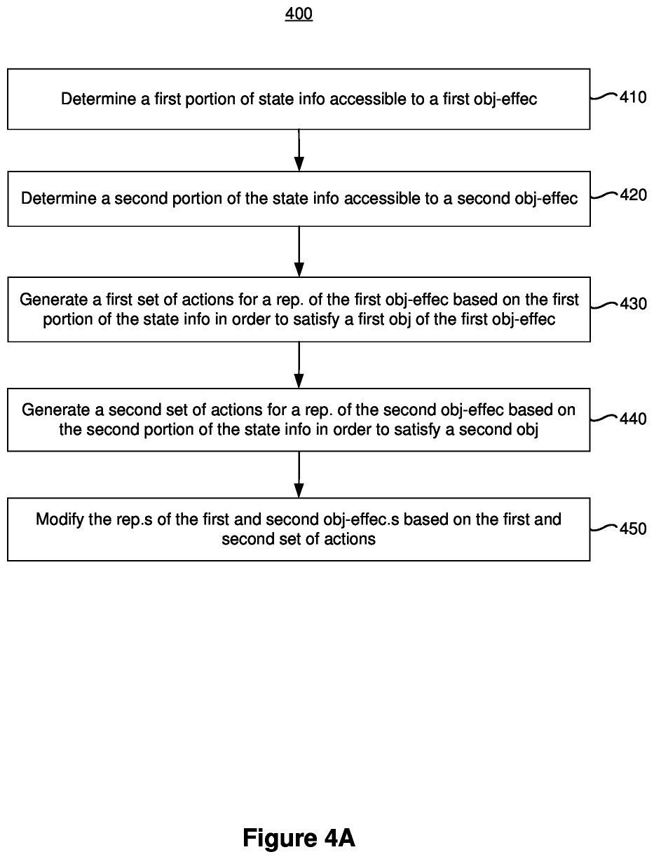

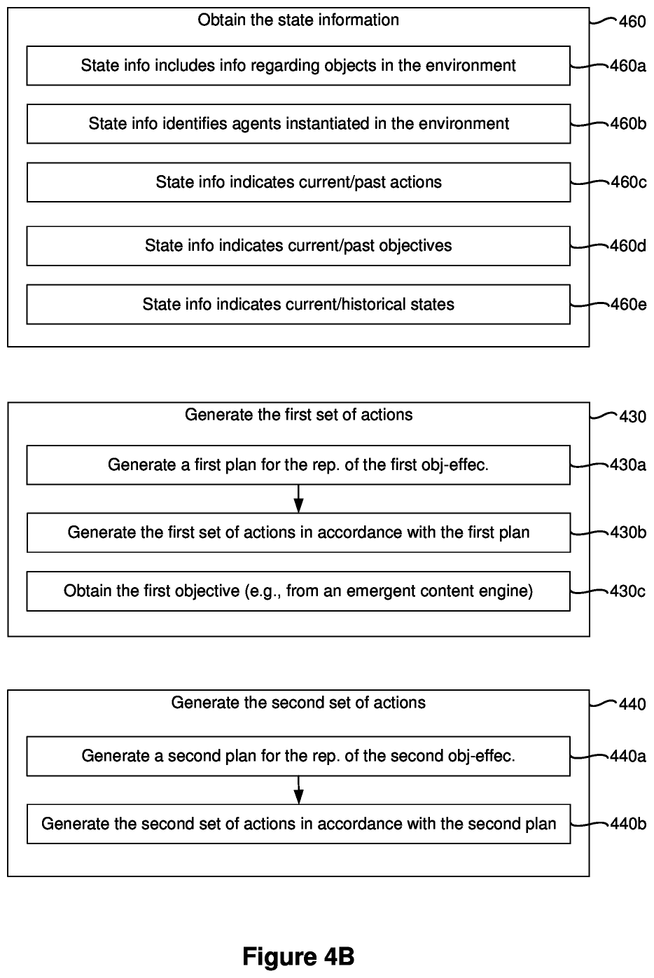

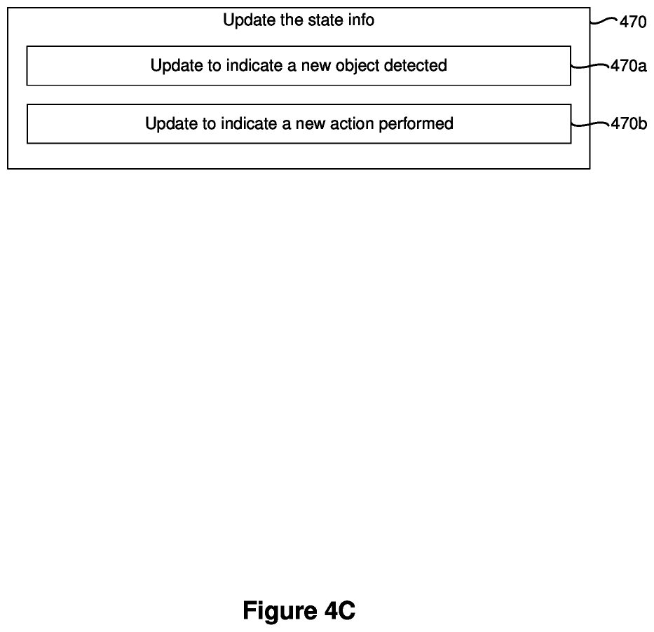

FIG. 4A is a flowchart representation of a method 400 of generating actions for objective-effectuators based on state information. In various implementations, the method 400 is performed by a device with a non-transitory memory and one or more processors coupled with the non-transitory memory (e.g., the controller 102 and/or the electronic device 103 shown in FIG. 1). In some implementations, the method 400 is performed by processing logic, including hardware, firmware, software, or a combination thereof. In some implementations, the method 400 is performed by a processor executing code stored in a non-transitory computer-readable medium (e.g., a memory).

As represented by block 410, in various implementations, the method 400 includes determining a first portion of state information that is accessible to a first objective-effectuator instantiated in an XR environment. For example, determining the first portion 272a of the state information 272, shown in FIGS. 2A-2B, that is accessible to the boy objective-effectuator represented by the boy action figure representation 108a in FIG. 1. In some implementations, the state information characterizes one or more portions of the XR environment. For example, as shown in FIG. 2B, the state information 272 includes XR object information 278, objective-effectuator information 280, information regarding current/past actions 282, information regarding current/past objectives 284, environmental information 286, and/or relational data 288. In some implementations, a first objective-effectuator engine (e.g., the first character engine 208a shown in FIGS. 2A-2B) determines the first portion of the state information. In some implementations, the method 400 includes obtaining (e.g., retrieving) the first portion of the state information from a state information datastore (e.g., the state information datastore 270 shown in FIG. 2A) that stores the state information. In some implementations, the method 400 includes identifying a knowledge of the first objective-effectuator.

As represented by block 420, in various implementations, the method 400 includes determining a second portion of the state information that is accessible to a second objective-effectuator instantiated in the XR environment. In some implementations, the second portion of the state information is different from the first portion of the state information. For example, determining the second portion 272b of the state information 272, shown in FIGS. 2A-2B, that is accessible to the girl objective-effectuator represented by the girl action figure representation 108b shown in FIG. 1. In some implementations, the second portion of the state information is determined by a second objective-effectuator engine (e.g., the second character engine 208b shown in FIG. 2A). In some implementations, the method 400 includes obtaining the second portion of the state information from the state information datastore. In some implementations, the method 400 includes identifying a knowledge of the second objective-effectuator.

As represented by block 430, in various implementations, the method 400 includes generating a first set of actions for an XR representation of the first objective-effectuator based on the first portion of the state information in order to satisfy a first objective of the first objective-effectuator. For example, as shown in FIGS. 2A-2B, the first character engine 208a generates the first set of actions 210a for the boy action figure representation 108a based on the first portion 272a of the state information 272 in order to satisfy one of the objectives 254 that corresponds to the boy objective-effectuator. In some implementations, the method 400 includes obtaining (e.g., receiving) the first objective from an emergent content engine (e.g., receiving the objectives 254 from the emergent content engine 250 shown in FIG. 2A).

As represented by block 440, in various implementations, the method 400 includes generating a second set of actions for an XR representation of the second objective-effectuator based on the second portion of the state information in order to satisfy a second objective of the second objective-effectuator. For example, as shown in FIGS. 2A-2B, the second character engine 208b generates the second set of actions 210b for the girl action figure representation 108b based on the second portion 272b of the state information 272 in order to satisfy one of the objectives 254 that corresponds to the girl objective-effectuator. In some implementations, the method 400 includes obtaining the second objective from an emergent content engine (e.g., receiving the objectives 254 from the emergent content engine 250 shown in FIG. 2A).

As represented by block 450, in various implementations, the method 400 includes modifying the XR representations of the first and second objective-effectuators based on the first and second set of actions. For example, modifying the boy action figure representation 108a in order to display the boy action figure representation 108a performing the first set of actions 210a, and modifying the girl action figure representation 108b in order to display the girl action figure representation 108b performing the second set of actions 210b.

Referring to FIG. 4B, as represented by block 460, in various implementations, the method 400 includes obtaining the state information characterizing the one or more portions of the XR environment. In some implementations, the state information is stored in the form of a graph. In some implementations, the state information is referred to as a knowledge graph. In some implementations, the state information is referred to as an ontology. In some implementations, the method 400 includes retrieving the state information from a datastore (e.g., the state information datastore 270 shown in FIGS. 2A-2C).

As represented by block 460a, in some implementations, the state information includes information regarding XR objects in the XR environment. For example, as shown in FIGS. 2B-2C, the state information 272 includes the XR object information 278.

As represented by block 460b, in some implementations, the state information identifies objective-effectuators that are instantiated in the XR environment. For example, as shown in FIGS. 2B-2C, the state information 272 includes objective-effectuator information 280.

As represented by block 460c, in some implementations, the state information indicates current actions or past actions of one or more objective-effectuators instantiated in the XR environment. For example, as shown in FIGS. 2B-2C, the state information 272 includes information regarding current/past actions 282.

As represented by block 460d, in some implementations, the state information indicates current objectives or past objectives of one or more objective-effectuators instantiated in the XR environment. For example, as shown in FIGS. 2B-2C, the state information 272 includes information regarding current/past objectives 284.

As represented by block 460e, in some implementations, the state information indicates a current state or one or more past states (e.g., historical states) of the XR environment. In some implementations, the current state indicates actions that XR representations of objective-effectuators are currently performing. In some implementations, the current state indicates objectives of objective-effectuators that are currently in effect. In some implementations, the past states indicate actions that XR representations of objective-effectuators have performed in the past. In some implementations, the past states indicate objectives of objective-effectuators that were in effect in the past.

As represented by block 430a, in some implementations, the method 400 includes generating a first plan for the XR representation of the first objective-effectuator based on the first portion of the state information. For example, as shown in FIG. 2B, the planner 212 generates the plan 214 based on the first portion 272a of the state information 272.

As represented by block 430b, in some implementations, the method 400 includes generating the first set of actions in accordance with the first plan. For example, as shown in FIG. 2B, the action generator 216 generates the first set of actions 210a in accordance with the plan 214.

As represented by block 430c, in some implementations, the method 400 includes obtaining the first objective for the first objective-effectuator. In some implementations, the method 400 includes receiving the first objective from an emergent content engine that generated the first objective. For example, as shown in FIG. 2A, the emergent content engine 250 provides the objectives 254 to the objective-effectuator engines 208.

As represented by block 440a, in some implementations, the method 400 includes generating a second plan for the XR representation of the second objective-effectuator based on the second portion of the state information. As represented by block 440b, in some implementations, the method 400 includes generating the second set of actions in accordance with the second plan.

Referring to FIG. 4C, as represented by block 470, in some implementations, the method 400 includes updating the first portion of the state information based on a new state detected by the XR representation of the first objective-effectuator. For example, as shown in FIG. 2B, the first character engine 208a generates updates 274 for the state information datastore 270.

As represented by block 470a, in some implementations, the method 400 includes updating the first portion of the state information in order to indicate a new XR object detected by the XR representation of the objective-effectuator. For example, as shown in FIG. 2B, the updates 274 include information regarding newly detected XR objects 274a.

As represented by block 470b, in some implementations, the method 400 includes updating the first portion of the state information in order to indicate a new action performed by the XR representation of the first objective-effectuator. For example, as shown in FIG. 2B, the updates 274 include the first set of actions 210a and/or the status 274b of the first set of actions 210a.

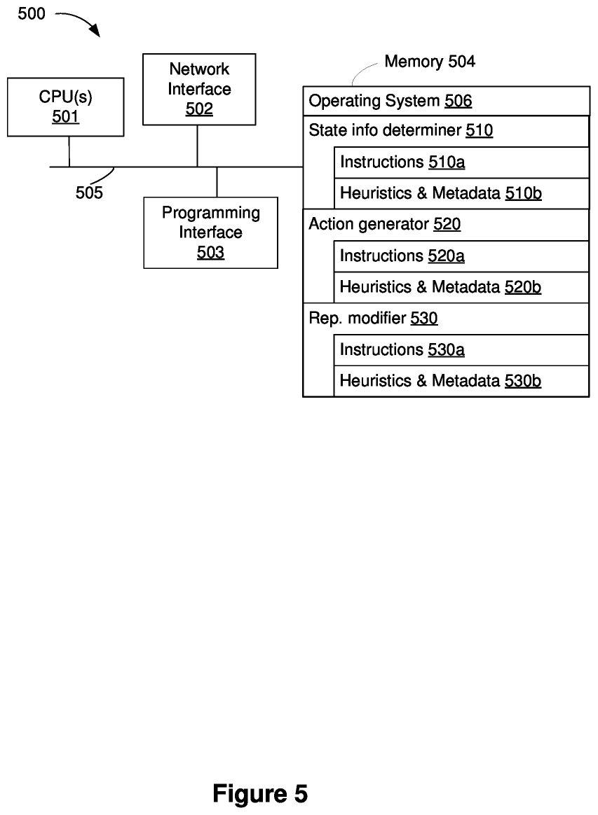

FIG. 5 is a block diagram of a device 500 enabled with one or more components of an objective-effectuator engine (e.g., one of the objective-effectuator engines 208 shown in FIG. 2A, for example, the first character engine 208a shown in FIGS. 2A-2B) in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units (CPUs) 501, a network interface 502, a programming interface 503, a memory 504, and one or more communication buses 505 for interconnecting these and various other components.

In some implementations, the network interface 502 is provided to, among other uses, establish and maintain a metadata tunnel between a cloud hosted network management system and at least one private network including one or more compliant devices. In some implementations, the communication buses 505 include circuitry that interconnects and controls communications between system components. The memory 504 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 504 optionally includes one or more storage devices remotely located from the CPU(s) 501. The memory 504 comprises a non-transitory computer readable storage medium.

In some implementations, the memory 504 or the non-transitory computer readable storage medium of the memory 504 stores the following programs, modules and data structures, or a subset thereof including an optional operating system 506, a state information determiner 510, an action generator 520, and an XR representation modifier 530. In various implementations, the device 500 performs the method 400 shown in FIGS. 4A-4C.

In some implementations, the state information determiner 510 determines a portion of state information that is accessible to an objective-effectuator instantiated in an XR environment. In some implementations, the state information determiner 510 performs the operation(s) represented by blocks 410 and/or 420 in FIG. 4A. To that end, the state information determiner 510 includes instructions 510a, and heuristics and metadata 510b.

In some implementations, the action generator 520 generates a set of actions for an XR representation of the objective-effectuator based on the portion of the state information in order to satisfy an objective of the objective-effectuator. In some implementations, the action generator 520 performs the operations(s) represented by blocks 430 and/or 440 shown in FIGS. 4A-4B. To that end, the action generator 520 includes instructions 520a, and heuristics and metadata 520b.

In some implementations, the XR representation modifier 530 modifies the XR representation of the objective-effectuator based on the set of actions. In some implementations, the XR representation modifier 530 performs the operations represented by block 450 in FIG. 4A. To that end, the XR representation modifier 530 includes instructions 530a, and heuristics and metadata 530b.

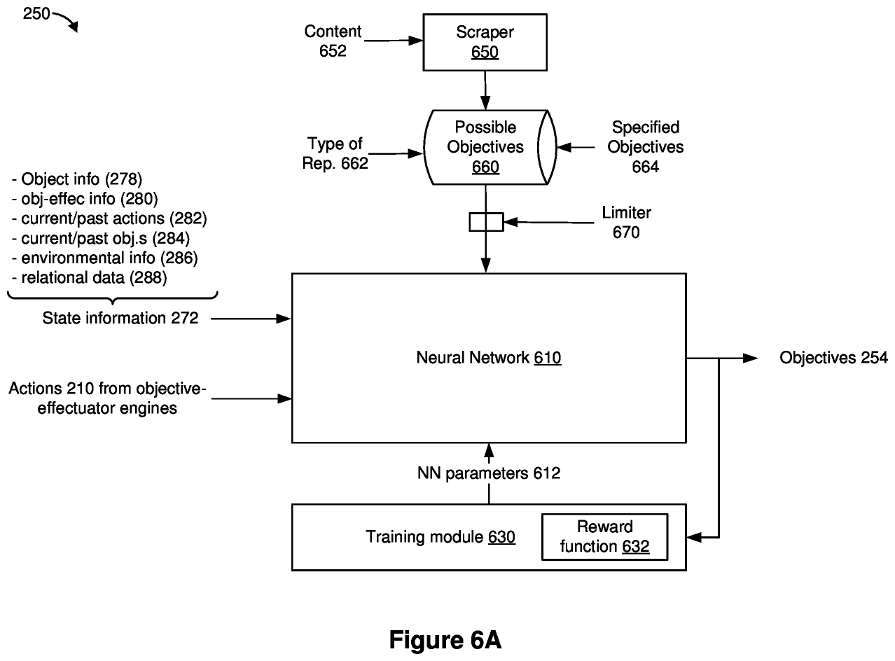

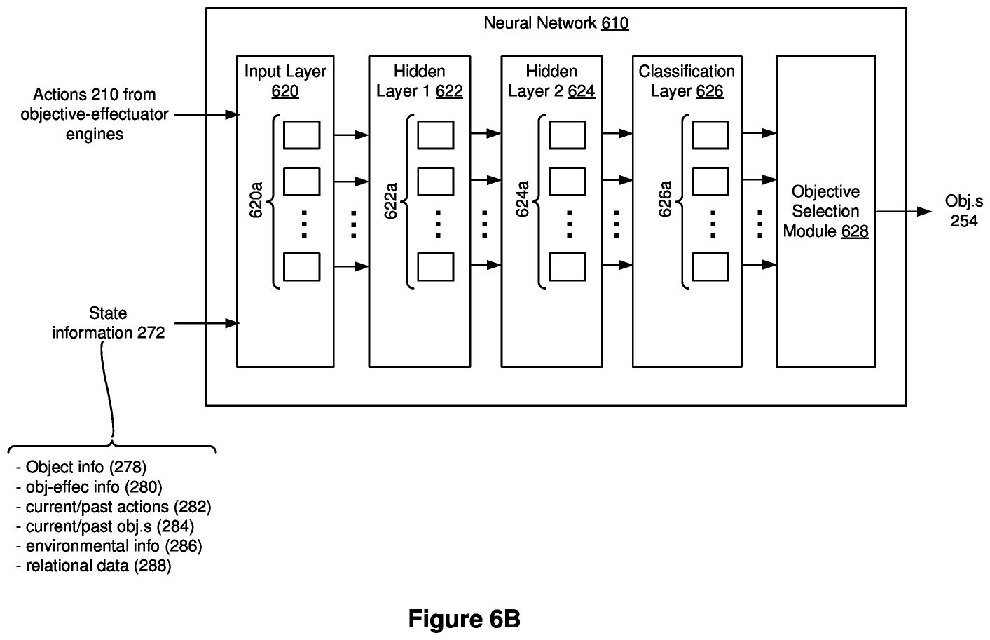

FIG. 6A is a block diagram of the emergent content engine 250 in accordance with some implementations. In various implementations, the emergent content engine 250 generates the objectives 254 for various objective-effectuators that are instantiated in an XR environment (e.g., the boy objective-effectuator, the girl objective-effectuator, the robot objective-effectuator and/or the drone objective-effectuator instantiated in the XR environment 106 shown in FIG. 1). In some implementations, at least some of the objectives 254 are for an environmental engine (e.g., the environmental engine 208e shown in FIG. 2A) that affects an environment of the XR environment.

In various implementations, the emergent content engine 250 includes a neural network system 610 (“neural network 610”, hereinafter for the sake of brevity), a neural network training system 630 (“a training module 630”, hereinafter for the sake of brevity) that trains (e.g., configures) the neural network 610, and a scraper 650 that provides possible objectives 660 to the neural network 610. In various implementations, the neural network 610 generates the objectives 254 based on the state information 272 characterizing the XR environment 106.

In some implementations, the neural network 610 includes a long short-term memory (LSTM) recurrent neural network (RNN). In various implementations, the neural network 610 generates the objectives 254 based on a function of the possible objectives 660. For example, in some implementations, the neural network 610 generates the objectives 254 by selecting a portion of the possible objectives 660. In some implementations, the neural network 610 generates the objectives 254 such that the objectives 254 are within a degree of similarity to the possible objectives 660.

In some implementations, the neural network 610 generates the objectives 254 based on the state information 272. For example, in some implementations, the objectives 254 include interfacing with XR objects indicated by the XR object information 278. In some implementations, the objectives 254 include cooperating with XR representations of the objective-effectuators indicated by the objective-effectuator information 280. In some implementations, the objectives 254 include reacting to the current/past actions 282 of various objective-effectuators. In some implementations, the objectives 254 include blocking current/past objectives 284 of other objective-effectuators. In some implementations, the objectives 254 are a function of the environmental information 286. For example, if the environmental information 286 indicates rain within the XR environment 106, then one of the objectives 254 includes staying dry. In some implementations, the objectives 254 are a function of the relational data 288. For example, one of the objectives 254 includes initiating a conversation with an XR representation of another objective-effectuator with whom there is a known relationship.

In some implementations, the neural network 610 generates the objectives 254 based on the actions 210 provided by various objective-effectuator engines. In some implementations, the neural network 610 generates the objectives 254 such that the objectives 254 can be satisfied (e.g., achieved) given the actions 210 provided by the objective-effectuator engines. In some implementations, the neural network 610 evaluates the possible objectives 660 with respect to the actions 210. In such implementations, the neural network 610 generates the objectives 254 by selecting the possible objectives 660 that can be satisfied by the actions 210 and forgoing selecting the possible objectives 660 that cannot be satisfied by the actions 210. In some implementations, the neural network 610 generates the objectives 254 based on a possible set of actions (e.g., the possible set of actions 209 shown in FIGS. 2B-2C).

In various implementations, the training module 630 trains the neural network 610. In some implementations, the training module 630 provides neural network (NN) parameters 612 to the neural network 610. In some implementations, the neural network 610 includes model(s) of neurons, and the neural network parameters 612 represent weights for the model(s). In some implementations, the training module 630 generates (e.g., initializes or initiates) the neural network parameters 612, and refines (e.g., adjusts) the neural network parameters 612 based on the objectives 254 generated by the neural network 610.

In some implementations, the training module 630 includes a reward function 632 that utilizes reinforcement learning to train the neural network 610. In some implementations, the reward function 632 assigns a positive reward to objectives 654 that are desirable, and a negative reward to objectives 654 that are undesirable. In some implementations, during a training phase, the training module 630 compares the objectives 254 with verification data that includes verified objectives. In such implementations, if the objectives 254 are within a degree of similarity to the verified objectives, then the training module 630 stops training the neural network 610. However, if the objectives 254 are not within the degree of similarity to the verified objectives, then the training module 630 continues to train the neural network 610. In various implementations, the training module 630 updates the neural network parameters 612 during/after the training.

In various implementations, the scraper 650 scrapes content 652 to identify the possible objectives 660. In some implementations, the content 652 includes movies, video games, comics, novels, and fan-created content such as blogs and commentary. In some implementations, the scraper 650 utilizes various methods, systems and/or, devices associated with content scraping to scrape the content 652. For example, in some implementations, the scraper 650 utilizes one or more of text pattern matching, HTML (Hyper Text Markup Language) parsing, DOM (Document Object Model) parsing, image processing and audio analysis to scrape the content 652 and identify the possible objectives 660.

In some implementations, an objective-effectuator is associated with a type of representation 662, and the neural network 610 generates the objectives 254 based on the type of representation 662 associated with the objective-effectuator. In some implementations, the type of representation 662 indicates physical characteristics of the objective-effectuator (e.g., color, material type, texture, etc.). In such implementations, the neural network 610 generates the objectives 254 based on the physical characteristics of the objective-effectuator. In some implementations, the type of representation 662 indicates behavioral characteristics of the objective-effectuator (e.g., aggressiveness, friendliness, etc.). In such implementations, the neural network 610 generates the objectives 254 based on the behavioral characteristics of the objective-effectuator. For example, the neural network 610 generates an objective of being destructive for the boy action figure representation 108a in response to the behavioral characteristics including aggressiveness. In some implementations, the type of representation 662 indicates functional and/or performance characteristics of the objective-effectuator (e.g., strength, speed, flexibility, etc.). In such implementations, the neural network 610 generates the objectives 254 based on the functional characteristics of the objective-effectuator. For example, the neural network 610 generates an objective of always moving for the girl action figure representation 108b in response to the behavioral characteristics including speed. In some implementations, the type of representation 662 is determined based on a user input. In some implementations, the type of representation 662 is determined based on a combination of rules.

In some implementations, the neural network 610 generates the objectives 254 based on specified objectives 664. In some implementations, the specified objectives 664 are provided by an entity that controls (e.g., owns or created) the fictional material from where the character/equipment originated. For example, in some implementations, the specified objectives 664 are provided by a movie producer, a video game creator, a novelist, etc. In some implementations, the possible objectives 660 include the specified objectives 664. As such, in some implementations, the neural network 610 generates the objectives 254 by selecting a portion of the specified objectives 664.

In some implementations, the possible objectives 660 for an objective-effectuator are limited by a limiter 670. In some implementations, the limiter 670 restricts the neural network 610 from selecting a portion of the possible objectives 660. In some implementations, the limiter 670 is controlled by the entity that owns (e.g., controls) the fictional material from where the character/equipment originated. For example, in some implementations, the limiter 670 is controlled by a movie producer, a video game creator, a novelist, etc. In some implementations, the limiter 670 and the neural network 610 are controlled/operated by different entities. In some implementations, the limiter 670 restricts the neural network 610 from generating objectives that breach a criterion defined by the entity that controls the fictional material.

FIG. 6B is a block diagram of the neural network 610 in accordance with some implementations. In the example of FIG. 6B, the neural network 610 includes an input layer 620, a first hidden layer 622, a second hidden layer 624, a classification layer 626, and an objective selection module 628. While the neural network 610 includes two hidden layers as an example, those of ordinary skill in the art will appreciate from the present disclosure that one or more additional hidden layers are also present in various implementations. Adding additional hidden layers adds to the computational complexity and memory demands, but may improve performance for some applications.

In various implementations, the input layer 620 receives various inputs. In the example of FIG. 6B, the input layer 620 receives inputs indicating the state information 272, the actions 210 from the objective-effectuator engines, and/or a possible set of actions for various objective-effectuators. In some implementations, the neural network 610 includes a feature extraction module (not shown) that generates a feature stream (e.g., a feature vector) based on the state information 272, the actions 210, and/or the possible set of actions. In such implementations, the feature extraction module provides the feature stream to the input layer 620. As such, in some implementations, the input layer 620 receives a feature stream that is a function of the state information 272, the actions 210, and/or the possible set of actions. In various implementations, the input layer 620 includes a number of LSTM logic units 620a, which are also referred to as neurons or models of neurons by those of ordinary skill in the art. In some such implementations, an input matrix from the features to the LSTM logic units 620a includes rectangular matrices. The size of this matrix is a function of the number of features included in the feature stream.

In some implementations, the first hidden layer 622 includes a number of LSTM logic units 622a. In some implementations, the number of LSTM logic units 622a ranges between approximately 10-500. Those of ordinary skill in the art will appreciate that, in such implementations, the number of LSTM logic units per layer is orders of magnitude smaller than previously known approaches (being of the order of O(10¹)-O(10²)), which allows such implementations to be embedded in highly resource-constrained devices. As illustrated in the example of FIG. 6B, the first hidden layer 622 receives its inputs from the input layer 620.

In some implementations, the second hidden layer 624 includes a number of LSTM logic units 624a. In some implementations, the number of LSTM logic units 624a is the same as or similar to the number of LSTM logic units 620a in the input layer 620 or the number of LSTM logic units 622a in the first hidden layer 622. As illustrated in the example of FIG. 6B, the second hidden layer 624 receives its inputs from the first hidden layer 622. Additionally or alternatively, in some implementations, the second hidden layer 624 receives its inputs from the input layer 620.

In some implementations, the classification layer 626 includes a number of LSTM logic units 626a. In some implementations, the number of LSTM logic units 626a is the same as or similar to the number of LSTM logic units 620a in the input layer 620, the number of LSTM logic units 622a in the first hidden layer 622 or the number of LSTM logic units 624a in the second hidden layer 624. In some implementations, the classification layer 626 includes an implementation of a multinomial logistic function (e.g., a soft-max function) that produces a number of outputs that is approximately equal to the number of possible objectives 660. In some implementations, each output includes a probability or a confidence measure of the corresponding objective being satisfied by the possible set of actions. In some implementations, the outputs do not include objectives that have been excluded by operation of the limiter 670.

In some implementations, the objective selection module 628 generates the objectives 254 by selecting the top N objective candidates provided by the classification layer 626. In some implementations, the top N objective candidates are likely to be satisfied by the possible set of actions. In some implementations, the objective selection module 628 provides the objectives 254 to a rendering and display pipeline (e.g., the display engine 260 shown in FIG. 2A). In some implementations, the objective selection module 628 provides the objectives 254 to one or more objective-effectuator engines (e.g., the first character engine 208a, the second character engine 208b, the first equipment engine 208c, the second equipment engine 208d, and/or the environmental engine 208e shown in FIG. 2A).

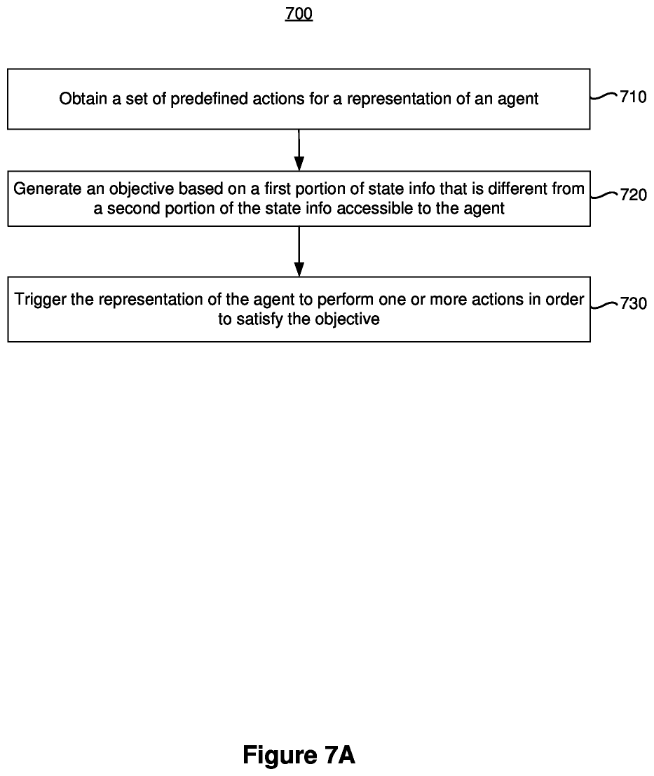

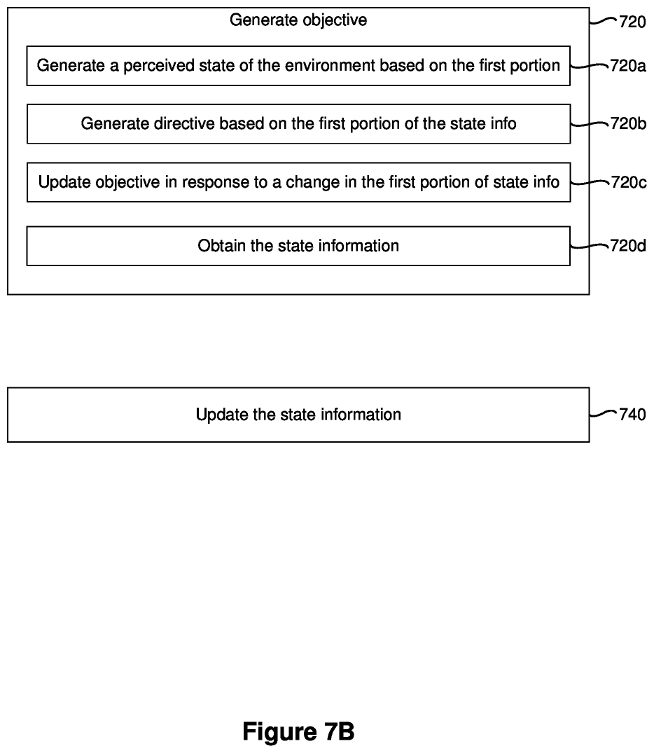

FIG. 7A is a flowchart representation of a method 700 of generating objectives for objective-effectuators based on state information. In various implementations, the method 700 is performed by a device with a non-transitory memory and one or more processors coupled with the non-transitory memory (e.g., the controller 102 and/or the electronic device 103 shown in FIG. 1). In some implementations, the method 700 is performed by processing logic, including hardware, firmware, software, or a combination thereof. In some implementations, the method 700 is performed by a processor executing code stored in a non-transitory computer-readable medium (e.g., a memory).

As represented by block 710, in some implementations, the method 700 includes obtaining a set of predefined actions for an XR representation of an objective-effectuator. For example, as shown in FIG. 2A, the emergent content engine 250 obtains the actions 210. In some implementations, the set of predefined actions represent a possible set of actions for the XR representation of the objective-effectuator. In some implementations, the set of predefined actions represent actions that the XR representation of the objective-effectuator is capable of performing in an XR environment. In some implementations, the set of predefined actions include actions that the XR representation of the objective-effectuator has performed in the past. In some implementations, the set of predefined actions include actions that the XR representation of the objective-effectuator is to perform in the future. In some implementations, the method 700 includes receiving the actions from objective-effectuator engines that generated the actions. In some implementations, the method 700 includes retrieving the actions from a datastore.

As represented by block 720, in some implementations, the method 700 includes generating an objective for the XR representation of the objective-effectuator based on the set of predefined actions and a first portion of state information characterizing the XR environment. For example, as shown in FIG. 2A, the emergent content engine 250 generates the objectives 254 based on the state information 272 and the actions 210. Similarly, as shown in FIG. 2C, the emergent content engine 250 generates the objectives 254 based on the state information 272 and the possible set of actions 209.

In some implementations, the first portion of the state information is different from a second portion of the state information accessible to the objective-effectuator. For example, the state information 272 is different from the first portion 272a of the state information 272 accessible to the boy objective-effectuator. In some implementations, the first portion of the state information is greater than the second portion of the state information. For example, the first portion 272a is a subset of the state information 272.

As represented by block 730, in some implementations, the method 700 includes triggering the XR representation of the objective-effectuator to perform one or more actions in order to satisfy the objective. In some implementations, the method 700 includes providing the objective to an objective-effectuator engine that generates actions for the XR representation of the objective-effectuator. For example, as shown in FIG. 2A, the emergent content engine 250 provides the objectives 254 to the objective-effectuator engines 208 that generate the actions 210 in order to satisfy the objectives 254.

Referring to FIG. 7B, as represented by block 720a, in some implementations, the method 700 includes generating a perceived state of the XR environment based on the first portion of the state information, generating the objective based on the perceived state. For example, as shown in FIG. 2C, the state information interpreter 256 generates the perceived state 257, and the objective generator 258 generates the objectives 254 based on the perceived state 257. In some implementations, the perceived state is different from an actual state of the XR environment. For example, in some implementations, the perceived state represents a biased interpretation of the actual state of the XR environment.

As represented by block 720b, in some implementations, the method 700 includes generating a directive for the XR representation of the objective-effectuator based on the portion of the state information and the objective. For example, as shown in FIG. 2C, the directive generator 259 generates the directives 262 based on the state information 272 and the objectives 254. In some implementations, the method 700 includes generating boundary conditions for the objective based on the portion of the state information. In some implementations, the method 700 includes limiting the set of predefined actions to a subset based on the portion of the state information and the objective.

As represented by block 720c, in some implementations, the method 700 includes detecting a change in the first portion of the state information, and modifying the objective in response to detecting the change. For example, in some implementations, if the state information 272 changes, then the emergent content engine 250 updates the objectives 254 based on the changes to the state information 272.

As represented by block 720d, in some implementations, the method 700 includes obtaining the state information (e.g., the first portion of the state information). In some implementations, the method 700 includes retrieving the state information from a datastore (e.g., the state information datastore 270 shown in FIGS. 2A-2C). In some implementations, the state information is stored in the form of a graph (e.g., a knowledge graph). In such implementations, the method 700 includes accessing the graph to obtain the state information. In some implementations, the state information is stored as an ontology. In such implementations, the method 700 includes accessing the ontology.

In some implementations, the method 700 includes obtaining information regarding XR objects in the XR environment (e.g., the XR object information 278 shown in FIG. 2C). In some implementations, the method 700 includes obtaining information that identifies objective-effectuators that are instantiated in the XR environment (e.g., the objective-effectuator information 280 shown in FIG. 2C). In some implementations, the method 700 includes obtaining information that indicates current actions or past actions of one or more objective-effectuators instantiated in the XR environment (e.g., the information regarding current/past actions 282 shown in FIG. 2C). In some implementations, the method 700 includes obtaining information that indicates current objectives or past objectives of one or more objective-effectuators instantiated in the XR environment (e.g., the information regarding current/past objectives 284). In some implementations, the method 700 includes obtaining information that indicates a current state or past states of the XR environment. In some implementations, the method 700 includes obtaining environmental information (e.g., the environmental information 286 shown in FIG. 2C). In some implementations, the method 700 includes obtaining relational data which indicates relationships between different objective-effectuators (e.g., the relational data 288 shown in FIG. 2C).

As represented by block 740, in some implementations, the method 700 includes updating the state information based on a status of the objective. For example, as shown in FIG. 2C, the emergent content engine 250 generates the updates 276 for the state information datastore 270. In some implementations, the method 700 includes updating the state information to indicate the new objectives (e.g., providing the new objectives 276a shown in FIG. 2C). In some implementations, the method 700 includes updating the state information to indicate that the objective has been satisfied (e.g., providing the objective status 276b shown in FIG. 2C). In some implementations, the method 700 includes updating the state information to indicate actions that the XR representation of the objective-effectuators performed in order to satisfy the objective. In some implementations, the method 700 includes updating the state information to indicate that the objective has not been satisfied (e.g., providing the objective status 276b shown in FIG. 2C). In some implementations, the method 700 includes indicating a portion of the objective that was not satisfied. In some implementations, the method 700 includes indicating planned actions that the XR representation of the objective-effectuator was not able to perform.

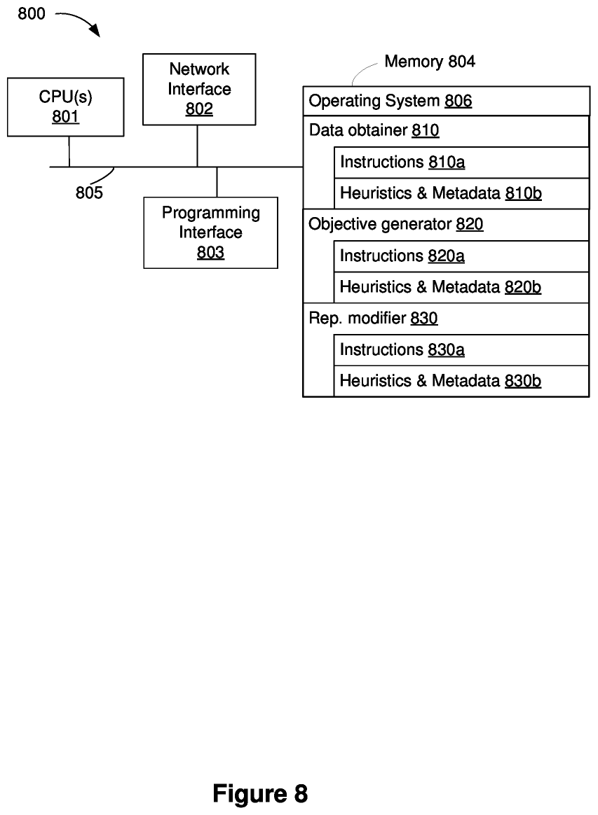

FIG. 8 is a block diagram of a device 800 enabled with one or more components of an emergent content engine (e.g., the emergent content engine 250 shown in FIGS. 2A, 2C and 6A-6B) in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units (CPUs) 801, a network interface 802, a programming interface 803, a memory 804, and one or more communication buses 805 for interconnecting these and various other components.

In some implementations, the network interface 802 is provided to, among other uses, establish and maintain a metadata tunnel between a cloud hosted network management system and at least one private network including one or more compliant devices. In some implementations, the communication buses 805 include circuitry that interconnects and controls communications between system components. The memory 804 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 804 optionally includes one or more storage devices remotely located from the CPU(s) 801. The memory 804 comprises a non-transitory computer readable storage medium.

In some implementations, the memory 804 or the non-transitory computer readable storage medium of the memory 804 stores the following programs, modules and data structures, or a subset thereof including an optional operating system 806, a data obtainer 810, an objective generator 820, and an XR representation modifier 830. In various implementations, the device 800 performs the method 700 shown in FIGS. 7A-7B.

In some implementations, the data obtainer 810 obtains a set of predefined actions for an XR representation of an objective-effectuator. In some implementations, the data obtainer 810 performs the operation(s) represented by block 710 in FIG. 7A. To that end, the data obtainer 810 includes instructions 810a, and heuristics and metadata 810b.

In some implementations, the objective generator 820 generates an objective for the XR representation of the objective-effectuator based on the set of predefined actions and a first portion of state information characterizing an XR environment. In some implementations, the objective generator 820 performs the operations(s) represented by block 720 shown in FIGS. 7A-7B. To that end, the objective generator 820 includes instructions 820a, and heuristics and metadata 820b.

In some implementations, the XR representation modifier 830 triggers the XR representation of the objective-effectuator to perform one or more actions in order to satisfy the objective. In some implementations, the XR representation modifier 830 performs the operations represented by block 730 in FIG. 7A. To that end, the XR representation modifier 830 includes instructions 830a, and heuristics and metadata 830b.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular embodiments only and is not intended to be limiting of the claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a non-transitory memory and one or more processors coupled with the non-transitory memory:
determining a first portion of state information that is accessible to a first agent instantiated in an environment, wherein the state information characterizes one or more portions of the environment;
determining a second portion of the state information that is accessible to a second agent instantiated in the environment, wherein the second portion of the state information is different from the first portion of the state information;
generating a first set of actions for a representation of the first agent based on the first portion of the state information to satisfy a first objective of the first agent, wherein the first set of actions is within a degree of similarity to actions that a first entity that the first agent models performs in a fictional material;
generating a second set of actions for a representation of the second agent based on the second portion of the state information to satisfy a second objective of the second agent, wherein the second set of actions is within a degree of similarity to actions that a second entity that the second agent models performs in the fictional material; and
modifying the representations of the first and second agents based on the first and second set of actions.

2. The method of claim 1, further comprising:
obtaining the state information characterizing the one or more portions of the environment.

3. The method of claim 1, wherein the state information includes information regarding objects in the environment.

4. The method of claim 1, wherein the state information identifies agents that are instantiated in the environment.

5. The method of claim 1, wherein the state information indicates current actions or past actions of one or more agents instantiated in the environment.

6. The method of claim 1, wherein the state information indicates current objectives or past objectives of one or more agents instantiated in the environment.

7. The method of claim 1, wherein the state information indicates a current state, or one or more past states of the environment.

8. The method of claim 1, wherein generating the first set of actions comprises:
generating a first plan for the representation of the first agent based on the first portion of the state information; and
generating the first set of actions in accordance with the first plan.

9. The method of claim 8, wherein the first plan includes a first bounded set of actions, and generating the first set of actions includes selecting the first set of actions from the first bounded set of actions.

10. The method of claim 1, wherein generating the second set of actions comprises:
generating a second plan for the representation of the second agent based on the second portion of the state information, wherein the second plan is different from the first plan; and
generating the second set of actions in accordance with the second plan.

11. The method of claim 10, wherein the second plan indicates a second bounded set of actions, and generating the second set of actions includes selecting the second set of actions from the second bounded set of actions.

12. The method of claim 1, further comprising:
obtaining the first objective for the first agent.

13. The method of claim 12, wherein obtaining the first objective comprises:
receiving the first objective from an emergent content engine that generated the first objective.

14. The method of claim 1, further comprising:
updating the first portion of the state information based on a new state detected by the representation of the first agent.

15. The method of claim 14, wherein updating the first portion of the state information comprises:
updating the first portion of the state information to indicate a new object detected by the representation of the first agent.

16. The method of claim 14, wherein updating the first portion of the state information comprises:
updating the first portion of the state information to indicate a new action performed by the representation of the first agent.

17. A device comprising:
one or more processors;
a non-transitory memory; and
one or more programs stored in the non-transitory memory, which, when executed by the one or more processors, cause the device to:
determine a first portion of state information that is accessible to a first agent instantiated in an environment, wherein the state information characterizes one or more portions of the environment;
determine a second portion of the state information that is accessible to a second agent instantiated in the environment, wherein the second portion of the state information is different from the first portion of the state information;
generate a first set of actions for a representation of the first agent based on the first portion of the state information to satisfy a first objective of the first agent, wherein the first set of actions is within a degree of similarity to actions that a first entity that the first agent models performs in a fictional material;
generate a second set of actions for a representation of the second agent based on the second portion of the state information to satisfy a second objective of the second agent, wherein the second set of actions is within a degree of similarity to actions that a second entity that the second agent models performs in the fictional material; and
modify the representations of the first and second agents based on the first and second set of actions.

18. A non-transitory memory storing one or more programs, which, when executed by one or more processors of a device, cause the device to:
determine a first portion of state information that is accessible to a first agent instantiated in an environment, wherein the state information characterizes one or more portions of the environment;
determine a second portion of the state information that is accessible to a second agent instantiated in the environment, wherein the second portion of the state information is different from the first portion of the state information;
generate a first set of actions for a representation of the first agent based on the first portion of the state information to satisfy a first objective of the first agent, wherein the first set of actions is within a degree of similarity to actions that a first entity that the first agent models performs in a fictional material;
generate a second set of actions for a representation of the second agent based on the second portion of the state information to satisfy a second objective of the second agent, wherein the second set of actions is within a degree of similarity to actions that a second entity that the second agent models performs in the fictional material; and
modify the representations of the first and second agents based on the first and second set of actions.

19. The non-transitory memory of claim 18, wherein the one or more programs further cause the device to:
obtain the state information characterizing the one or more portions of the environment.

20. The non-transitory memory of claim 18, wherein the state information includes information regarding objects in the environment.
